(19) United States
(12) Patent Application Publication
(10) Pub. No.: US 2011/0008503 A1
(43) Pub. Date: Jan. 13, 2011

(54) METHOD AND APPARATUS FOR ENHANCING BIOLOGICAL PRODUCT SAFETY, FLAVOR, APPEARANCE AND SHELF-LIFE

(75) Inventors: Billy M. Groves, Rogers, AR (US); Ethan Whitbeck, Springdale, AR (US)

Correspondence Address: ARENT FOX LLP, 1050 CONNECTICUT AVENUE, N.W., SUITE 400, WASHINGTON, DC, 20036, US

(73) Assignee: Grovac Systems International, LC, Rogers, AR (US)

(21) Appl. No.: 12/440,751

(22) PCT Filed: Sep. 13, 2007
(86) PCT No.: PCT/US07/78427

§ 371 Date: Mar. 1, 2010

Related U.S. Application Data
(60) Provisional application No. 60/844,223, filed on Sep. 13, 2006.

(51) Int. Cl. A23L 3/34; A01N 3/02; A01G 5/06; B01J 19/00; B05C 11/00; B65D 81/20

(52) U.S. Cl. 426/331; 427/4; 422/292; 118/50; 118/712; 118/688; 99/472

(57) ABSTRACT

A method and apparatus by which flowers or food products are treated for the elimination of pathogenic and spoilage bacteria, the scavenging of free radicals that cause oxidative decay, the enhancement of flavor, the stabilization of fats, and the extension of shelf life that consists of alternately exposing the product to a vacuum environment and a saline solution containing organic acids for a predetermined period of time, including such method and means that includes automated devices that is pre-programmed to maximize effectiveness of the process for its intended purpose while minimizing any associated damage to the processed product.

### CROSS REFERENCE TO RELATED APPLICATIONS

This application claims the benefit of U.S. Provisional Patent Application No. 60/844,223 filed Sep. 13, 2006.

### FIELD OF INVENTION

The present invention relates in general to the processing of biological and food products and, more specifically, for processing said food and biological products to reduce bacteria and fat content and improve flavor, product appearance, and shelf-life.

### BACKGROUND OF INVENTION

The food processing industry is continually developing new approaches to preparing food products for human consumption. Generally, these approaches attempt to improve the overall consistency and quality of food and biological products delivered to the consumer. In addition, there is a desire in other industries that handle and process certain biological products that end-consumers see and purchase, such as cut flowers, to improve their appearance and shelf-life. In particular, processors adopt various methods and systems to improve the safety, flavor, shelf life, appearance, and/or nutrition of consumer-purchased biological and food products.

One approach to processing food products places the food product in a tumbler filled with a saline solution. The ham processing industry, for example, uses a tumbler to dramatically increase the water content of ham, sometimes as much as one hundred percent from its pre-tumbling weight. Another approach utilizes a tumbler partially evacuated and filled with a saline solution for alternately exposing the food products to the saline solution and partial vacuum. The hydration achieved using a vacuum tumbler is typically significantly lower than the hydration achieved when processing hams using a conventional tumbler.

Previous processing systems have experienced some success in enhancing the overall quality and consistency of food products. For example, U.S. Pat. No. 5,543,163, issued Aug. 6, 1996 to Billy M. Groves, details a method for enhancing the flavor and shelf life of food products by using a vacuum tumbler to alternately expose the product to a partial vacuum atmosphere and a process solution environment to treat products and remove fats that cause an “off-flavor” in fish products. Another example is U.S. Pat. No. 6,896,921, issued May 24, 2005 to Billy M. Groves, et al., in which a method for reducing bacteria and fat content for food products by using a vacuum tumbler to alternately expose the product to partial vacuum atmosphere and a pH-controlled processing solution to significantly reduce bacteria content and fat and improve product appearance is claimed. The aspects and features of these two patents are incorporated by reference.

These previous approaches, although successful to a degree, have not provided the means for a commercial industry user, such as a food processor, to optimize both the overall processing time as well as the times of alternating partial vacuum exposure and processing solution submersion for the product biological or food type. Positive benefits for optimizing the alternating exposure and submersion times include maximizing killing bacteria (e.g., E. coli, Salmonella, Listeria) that cause harm to humans and reduce shelf-life that may be present in the biological or food products; enhancing product flavor by removing bacteria, natural fats, and chemicals that produce “off-flavors” to consumers (e.g., Geosmin); retarding oxidative decay by stabilizing fats and scavenging free-radical iron and oxygen; and minimizing overall processing time and submersion time to the processing solution. Additionally, these prior techniques could not be used on food and biological products such as cut flowers, nuts, vegetables, fruit, coffee beans, or soybeans, where either their size (beans) or sensitivity to physical appearance (cut flowers are fragile; fruits and vegetables “bruise”) would prevent them being tumbled effectively and/or economically in this type of process. A method and apparatus that would permit such an assortment of physically different biological and food products to be processed as well as handle them in a manner to prevent physical damage to their exterior appearance is strongly desired. The improvement in handling and consumption safety, longevity, flavor, nutrition, and appearance of these products will appeal to both processors and end-consumers.

### SUMMARY OF INVENTION

The present invention provides a method for reducing bacteria, fat content, and free-radical and other “off-flavor” producing chemicals in food products that substantially eliminates or reduces the disadvantages and problems associated with previous methods and systems. The present invention also permits the processing of foods and biological products, such as nuts, coffee beans, soybeans, vegetables, fruits, and cut flowers, that could not be processed in this manner due to the harshness of the mechanical nature of the prior processing methods and apparatuses before but would benefit from such processing.

In one embodiment of the present invention a method for processing a plurality of biological products (which, by definition, include food products) includes loading a biological product into a dip vacuum processor, partially filling the dip vacuum processor with a combination of water, saline solution, and organic acid(s) to create a process solution based upon the biological product to be processed, withdrawing air from the dip vacuum processor to create a partial vacuum, actuating the dip vacuum processor for a predetermined overall processing time to expose the biological product to a set of alternating time periods of immersion in the processing solution and exposure to the partial vacuum environment, and removing the biological products from the dip vacuum processor after the overall processing time had elapsed.

The invention provides a number of technical benefits and advantages not present in previous applications and devices. Embodiments of the invention provide a number of technical advantages. Embodiments of the invention may include all, some, or none of these advantages. In one application, improved shelf life of processed biological product is a realized benefit. The processing promotes microbial intervention, which greatly diminishes the bacteria count in the biological product that results in degradation of the product. The process also stabilizes fat and scavenges free oxygen and iron radicals found in tissue that promote oxidative decay. This process improves shelf-life not only chemically but biologically, making it superior to traditional radiation treatment, a method that only eliminates biological actors, not chemical actors, on decay.

In another application, a reduction in total fat content of the processed food products is promoted. Some fats are chemically stabilized and others are removed, promoting a nutritionally healthier product. Cholesterol and triglycerides may also be reduced in certain biological products after treatment.

Another technical benefit of the invention includes enhanced appearance and taste of processed biological products in some applications. The taste of the food products may be enhanced by removing fats and chemicals, such as Geosmin, that contribute to an “off-flavor” problem. In another embodiment, a combination of mechanically perforating the biological product and vacuum dip processing produces food products with the benefit of a fresher appearance and a more pleasant odor. Perforations allow greater penetration of the processing solution to reduce the fat content, lower the bacteria count, and extract off-flavor chemicals without sacrificing the appearance and integrity of the cellular membrane. A similar result may also result from chemically pre-treating the biological product before vacuum dip processing. Embodiments of the invention may include, but are not limited to, pre-treatment steps like chlorine solution washing to remove mold from vegetables such as sweet potatoes or bicarbonate solution showering or rinsing to treat fresh fish products.

Another advantage includes improved safety of processed biological products for both processors and consumers for a variety of biological products. The optimization of both the predetermined overall processing time and the predetermined set of alternating cycles of time of immersion in a processing solution and exposure to the partial vacuum lays bare the biological product to rapidly and repetitively changing dual pressure and chemical environments. These rapid and repetitive changes cause both pathogenic (i.e., E. coli, Salmonella, Listeria) and spoilage bacteria to structurally deteriorate and collapse, thereby killing them. The destruction of bacteria effectively sanitizes the biological product without significantly altering the macro physical or nutritional attributes of the biological product, thereby making foods safer for human consumption (after proper preparation) and promoting other side-benefits in other products, like longer shelf-life in cut flowers. The optimization to maximize these desired effects would consider many different factors, such as the type and amount of biological product to process, the bacteria to be destroyed, the processing solution characteristics, and strength of the partial vacuum. For example, the predetermined overall processing time and the predetermined set of alternating cycles of time of immersion in a processing solution and exposure to the vacuum environment may be different for processing a pork product than for a batch of lettuce. This system permits the flexibility to optimize the process to provide effective bacterial removal based upon the quality of the end product desired.

A further technical advantage is that this system may include a variety of sensors, including pH sensors, analyzers, and scales, under observation by a control program run on a computer to allow further automation and control of the process as well as optimization of performance by a control program after numerous runs through empirical correlation. More particularly, a motor and vacuum source for the vacuum dip processor may be controlled by a computer in response to data received from an analyzer for measuring inputs such as fat content, bacteria count, and strength of acidity. The predetermined overall processing time, the predetermined set of alternating cycle times of immersion and exposure, the amount of partial vacuum generated, the overall pH level of the processing solution, and the amounts and types of organic acid(s) and additives included in the process solution may be adjusted based on measurements of the pretreated and post-processed biological products to reach an overall desired and consistent effect. In a simpler embodiment of the aforementioned process control scheme, the pH level of the processing solution of the processing solution is maintained at a relatively constant level throughout the processing cycle based on schedules or tables stored in the computer's memory that instruct a microprocessor to send commands to organic acid sources to inject a predetermined amount of one or more types of organic acid(s) into the process without resorting to the input from a pH sensor.

Another technical advantage of the invention is the level of automation incorporated. The incorporation of a microprocessor with predetermined control programming and instructions to send predetermined commands to material sources such as water, organic acid(s), saline solution, additives, vacuum motors, and piston effectively frees the operator to only be concerned with the proper selection of the biological product to treat. The invention treats the selected biological product in the partial vacuum atmosphere and processing solution based upon predetermined exposure and submersion time schedules as well as for a predetermined overall length of processing time based upon the product selected by the operator. The invention also mixes the proper components (both types and quantities) to create the proper processing solution for the biological material selected by the operator as well as lowers the atmospheric pressure in the vacuum dip processor to the proper level for vacuum treatment. This removes a significant amount of human intervention, permits more effective use of the operator's time while processing occurs, and produces a more consistent product from the vacuum dip processor.

### BRIEF DESCRIPTION OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 illustrates the processing steps and components of the vacuum dip process for processing biological and food products in accordance with the present invention; and

FIG. 2 illustrates the vacuum dip processor's control panel of the claimed invention.

FIG. 3 is a flow diagram illustrating the sequence of process steps and information flow of the process of FIG. 1.

### DETAILED DESCRIPTION OF THE INVENTION

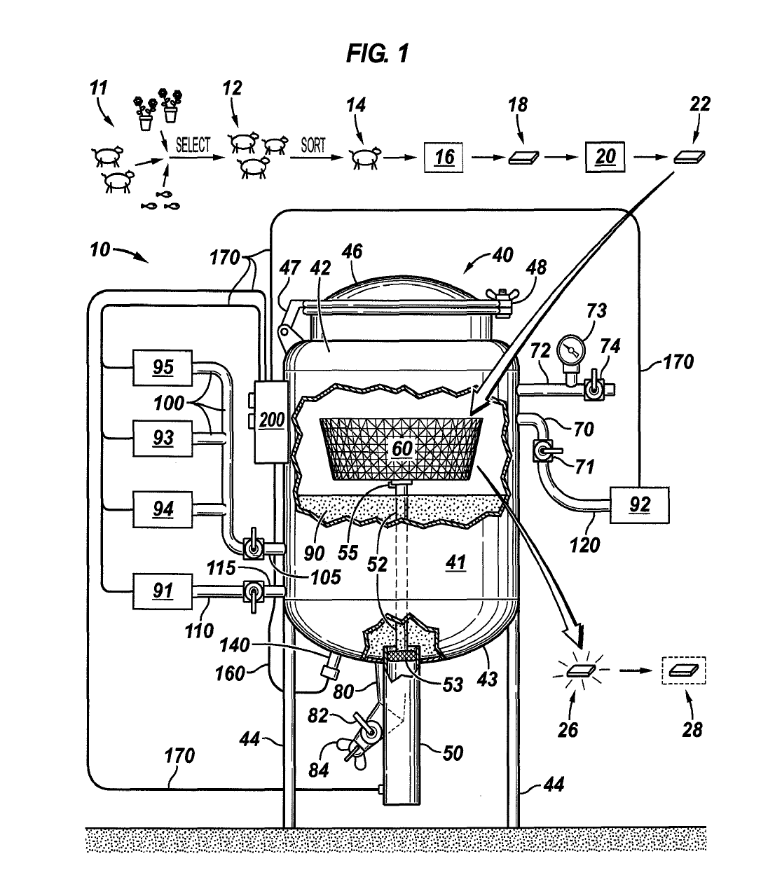

The principles of the present invention and their advantages are best understood by referring to FIGS. 1-3 of the drawings, like numerals being used for like and corresponding parts of the various drawings.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

The present invention contemplates a method for processing food products, such as those derived from biological products, a system, and an apparatus for carrying out the method. The present invention is described herein with reference to processing red meat, but other suitable biological and food products may be processed with minor variations and similar success. For example, the present invention may be used with success, but is not limited to in use, on such food and biological products as chicken, shrimp, fish, shell fish, coffee beans, soybeans, nuts, vegetables, fruits, and cut flowers.

The present invention reduces the total fat content of processed food products and potentially reduces cholesterol and triglycerides in certain biological products, making the treated products relatively healthier for consumers versus the same untreated products. In addition, the present invention also improves shelf life of processed animal and plant products by reducing bacteria that cause spoilage as well as removing chemicals that either cause degradation, such as free radical iron and oxygen, and the “off-flavor” taste, such as Geosmin, in some food products. The present invention, most importantly, is believed to eliminate pathogenic bacteria such as E. coli, Salmonella, and Listeria, making products safer to handle and consumable by both product processors and the public. To facilitate these advantages, and other advantages, the present invention uses several mechanical and chemical aspects conjointly.

For example, one mechanical aspect of the present invention is vacuum dip processing, which enhances cleaning and exposes greater cellular membrane area to the process by creating a net negative pressure environment outside the cellular membrane wall. Vacuum dip processing may also contribute to bacterial lysis, which improves the shelf life of the food products. Another mechanical aspect of one embodiment of the present invention is product pre-treatment, such as tissue perforation, especially of the membrane covering areas, or stem trimming, which assures a more uniform, direct, and extensive exposure of the food or biological products to vacuum dip processes and treat the areas where bacterial or chemical contamination may be highest, such as in the near-surface tissues of meat products or at the severance point for stems.

Various chemical aspects of the present invention also enhance the safety, quality, flavor of the food products, and improve their shelf life. A saline solution enhances osmosis into the cellular structure, which contributes significantly to bacterial lysis and fat reduction. Organic acid additives that are safe both to handle by biological product processors and to consume by the public, such as citric and ascorbic acids, help to adjust and maintain the pH of the processing solution, scavenge for product-degrading chemicals like free radical iron and oxygen, stabilize fats, weaken cellular structures of both pathogenic and degradation bacteria, and extract “off-flavor” chemical components from foods such as Geosmin. The organic acid(s) combinations and concentrations can be optimized depending on each biological product to be treated to maximize desired effects. The same organic acid additive(s) or another organic acid may be used to re-establish the integrity of the cellular membrane in some embodiments.

FIG. 1 illustrates the process steps and components of a process 10 for processing biological products in accordance with one embodiment of the present invention. Process 10 is described herein with reference to red meat; however, the process 10 may be used successfully with other suitable food and biological products, which includes but are not limited to fish, poultry, fruits, shrimp, shell fish, vegetables, nuts, soybeans, coffee beans, and cut flowers. The process steps performed in the process 10 are shown in a particular order but may be performed in a different sequence without departing from the scope and spirit of the present invention. In addition, process steps may be performed at a single location at multiple locations.

Referring to FIG. 1, a selected feedstock 12, in this case an animal type giving red meat, is chosen from a variety of a feedstocks 11 that may be processed by the present invention. The selected feedstock 12 of varying shapes and sizes are gathered and sorted based on size, appearance, or other appropriate characteristics to select sorted feedstock 14 appropriate for processing by the process 10. A sorted feedstock 14 is then processed by any suitable raw processing process 16 to produce a plurality of raw products, such as fillet 18. For example, cattle would have to be slaughtered and butchered to produce the fillet 18. As given for the example, the fillet 18 is assumed to be de-boned, eviscerated, and having a generally rectangular shape. The fillet 18 may include bones, internal organs, and other portions not intended for human consumption, and may be any suitable shape or size. Fillet 18 is then ready for the various processing steps performed by the process 10.

The fillet 18 may then be mechanically or chemically treated in a pretreatment process 20 to allow better tissue access during processing. For example, fillet 18 may be mechanically perforated in pretreatment process 20 to create pretreated fillets 22. In reference to the foregoing example, red meat typically does not have to be perforated, but perforation may be beneficial for some other food or biological products. Other mechanical or chemical processes may occur at this step to transform fillets 18 into pretreated fillets 22 for further processing and will depend on the food or biological product to be processed. For example, the fillets 18 may be treated with potassium chloride, sodium phosphate, or potassium phosphate solutions or powders to prepare it for vacuum dip processing.

Pretreated fillets 22 are then loaded into a container 60 within the vacuum dip processor 40. In this embodiment, the vacuum dip processor 40 is comprised of a cylindrical-shaped drum 41 with a domed top 42 and domed bottom 43. The vacuum dip processor 40 is made of suitable materials, such as stainless steel 316 in this embodiment, that are able to withstand repeated cycling of internal pressures between a partial vacuum and atmospheric conditions as well as prolonged exposure to acidic liquid conditions. The vacuum dip processor's 40 interior is accessed via the domed top lid 46 by elevating the lid 46 on hinges 47 attached to the domed top 42. Other embodiments may permit different access to the vacuum dip processor's 40 interior for use and maintenance. Other embodiments allows access to the interior of the vacuum dip processor 40 by way of door mounted on the side of the drum 41 that can be attached either via hinges, allowing the door to open and swing outwardly from the drum 41, or on sliding rails, permitting the door to be raised vertically. In the current example, when the lid 46 is closed and locked into place on the domed top 42 with locks 48, an air-tight compartment is formed within the vacuum dip processor 40. The vacuum dip processor 40 as a unit is raised off the ground and held aloft by several attached legs 44.

A piston cylinder 50 is attached to the domed bottom 43. The piston cylinder 50 drives a rod 52 from below the drum 41 through a piston seal 53 at the bottom of the domed bottom 43 upwardly into the drum's 41 interior. Piston cylinder 50 may be driven by hydraulic, air, gas, or water power and is actuated by its respective components. The rod's 52 range of movement allows the container 60 to rise and fall within specified parameters inside the vacuum dip processor 40, preferably in a range from complete submersion of the contents of the container 60 in the processing solution 90 to complete exposure to the partial vacuum environment.

In this embodiment, the container 60 is made out of a non-corroding metal, such as stainless steel 316. Container 60 has perforations or is made from a mesh-like material, thereby allowing the processing solution 90 to fill the container 60 when submerged into the processing solution 90 and to drain from the container 60 when positioned outside the process solution 90. The container 60 is attached to the rod 52 by a quick connection/release mechanism 55. Although in this embodiment container 60 is described, other containers in which the pretreated fillets 22 are contained may be used, such as a perforated tray. The shape, organization, and method of containment of the container 60 will likely vary depending on the biological or food product being processed, such as using an enclosed basket shape for small, non-bundled foods such as coffee beans or nuts and a perforated tray shape for large items like whole shanks of meat.

Two valve ports are attached to the drum 41 to provide the ability to draw, monitor, and break the partial vacuum in the vacuum dip processor 40. A vacuum line port 70 is located above the surface of the processing solution 90, preferably as high up on the body of the drum 41 as possible, and provides attachment for a ball valve 71. A vacuum release port 72 is also located above the steady-state surface of the processing solution and provides for two attachments: a vacuum pressure gauge 73 and a ball valve 74. The two ball valves 71 and 74 and the vacuum pressure gauge 73 are made of suitable materials, such as stainless steel 316 in this embodiment, to withstand repeated exposure to the processing solution 90 as well as correspond with the materials of manufacture of the vacuum dip processor 40.

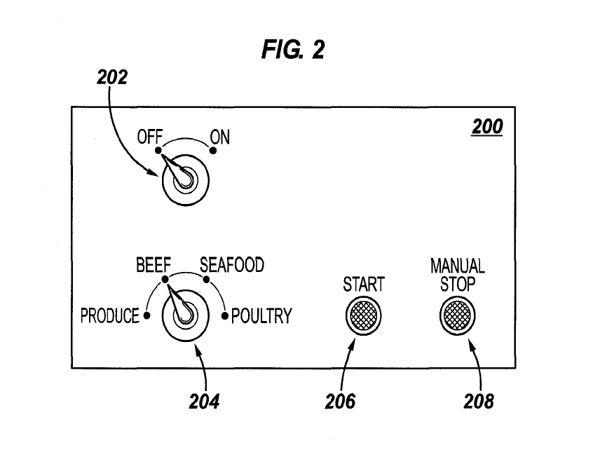

After loading the pretreated fillets 22 into container 60, the operator closes and seals the vacuum dip processor 40 by locking the lid 46 against the top dome 42 by tightening down the locks 48. There may be one or more locks 48 used to secure the lid 46 against the top dome 42. FIG. 1 shows the container 60 in the position where the operator would load the pretreated fillets 22. This position also represent a “default” position for the container 60. Referring now to FIG. 2 for a control panel 200, the operator then activates the process by turning on the vacuum dip processor 40 by manipulating an on/off switch 202 into the “ON” position, manipulating a process selection switch 204 to the desired process, and pressing a start button 206 on the control panel 200. The combination of the position of the process selection switch 204, depression of the start button 206, and the corresponding pH value of the water used for mixing the process solution 90, determines the combination of ingredients to use, the amount of each ingredient used to combine in vacuum dip processor 40 to create the processing solution 90, the strength of the partial vacuum to be created by a vacuum source 92, the length of overall processing time to treat the pretreated fillets 22 in the vacuum dip processor 40, and the respective lengths of intermediate time for exposing pretreated fillets 22 to the partial vacuum and the processing solution 90. The input variables are read by a PC-programmed microprocessor 150 (not shown). The microprocessor 150 in response to these inputs issues output commands through control lines 170 to initiate and control the process.

Referring back to FIG. 1, at initiation of the processing cycle, the microprocessor 150 sends commands via the control lines 170 to the saline solution source 93, the organic acid(s) source 94, and the additive(s) source 95, respectively, to dispense the proper volumes and combinations of concentrated materials (“concentrates”) through process lines 100 into the vacuum dip processor 40 via the concentrates nozzle 105. In this embodiment of the invention, only one concentrates nozzle 105 is considered; however, each concentrate source may have its own respective concentrates nozzle 105 attached to the vacuum dip processor 40 or may share a concentrates nozzle 105 in combination with another concentrates source. The amount and combination of each process solution 90 component is predetermined based upon the biological or food product to be processed and the water's pH value. Water is dispensed from the water source 91 into the vacuum dip processor 40 through the water line 110 via the water nozzle 115 in a similar manner as the concentrates, but with sufficient force as to mix and solublize the other components. The mixture of water, saline solution, additives, and organic acid(s) creates the processing solution 90.

The microprocessor 150 also sends commands via the control line 170 to the vacuum source 92. Upon receiving a command from the microprocessor 150, the vacuum source 92 begins to pull a partial vacuum within the vacuum dip processor 40 through a vacuum line 120. Vacuum line 120 is attached to the vacuum dip processor via the ball valve 71, which is attached to the vacuum line port 70.

After the processing solution 90 is created and the partial vacuum environment is established, the microprocessor 150 issues commands via the control line 170 to the piston cylinder 50 so that the rod 52 is manipulated in a manner so as to expose the pretreated fillets 22 to alternating periods of submersion in the processing solution 90 and exposure to the partial vacuum. This repeated and alternating cycle of exposure and submersion eventually transform the pretreated fillets 22 into a vacuum treated fillets 26.

The overall length of processing time, the intermittent time of partial vacuum exposure, and the intermittent time of process solution 90 submersion are controlled and monitored by the microprocessor 150 based upon the operator's selection of the food or biological product to process. For example, if the operator selects “Ground beef” using the process selection switch 204, the microprocessor 150, after both the process solution 90 and partial vacuum environments had been established, would actuate the piston cylinder 50 to position the rod 52 in a first position that exposes the container 60 and its contents to the partial vacuum for a total duration of five seconds. After five seconds, the microprocessor 150 would actuate the piston cylinder 50 again to position the rod 52 in a second position that submerges the container 60 and its contents in the processing solution 90 for a duration of three seconds. After three seconds, the microprocessor repeats actuation commands to the piston cylinder 50 that alternates the rod's 52 position between the first position for five seconds and the second position for three seconds. This series of timed commands from the microprocessor 150 to the piston cylinder 50 effects repeated “dunking” of the container 60 and its contents from the partial vacuum into the processing solution 90 and back into the partial vacuum environment. The series of alternating commands issued by the microprocessor 150 to the piston cylinder 50 continues until an overall processing time has elapsed.

The different preset timed exposures for the biological or food product to the partial vacuum and the processing solution 90 represents a novel and superior optimization of the process 10 not available in the prior art. The differentiation of exposure and submersion times gives treated biological or food products maximum benefits of vacuum dip processing—destruction of bacteria, removal of “off-flavor” chemicals, removal and stabilization of fats, improvement of shelf life—while minimizing exposure of the biological or food product to the processing solution 90. Additionally, the preset exposures controlled by a microprocessor free the operator from monitoring and acting in the vacuum dip process itself, thereby improving reliability of product produced and freeing the operator from the burdens of the treatment process. As well, the repeated “dunking” motion is novel and superior to the prior art “tumbling” motion because it is gentler and easier to control, and permits materials that cannot easily be tumbled, such as cut flowers, nuts, coffee beans, soybeans, fruits and vegetables, to be processed using the process 10.

During the processing of pretreated fillets 22 into vacuum processed fillets 26, the microprocessor monitors the pH of the processing solution 90 by receiving pH data input via data collection line 160 from a pH sensor 140 attached to the vacuum dip processor 40. Upon the pH value exceeding a predetermined threshold value, the microprocessor 150 commands the organic acid(s) source 94 to dispense the proper volumes and combinations of organic acid(s) to the vacuum dip processor 40 via process lines 100. The organic acid(s) dispensed are incorporated into the process solution 90 to readjust the processing solution's 90 pH back into the desired operating range. The proper volumes and combinations of organic acid(s) dispensed may reflect the product being processed by the vacuum dip processor 40 via input received from the product selection switch 204. Microprocessor 150 may perform this adjustment step as many times as required to maintain the processing solution's 90 pH in a predetermined operating range. In one embodiment, the microprocessor 150 may control the process solution's 90 pH range within a range between and including pH values of 1 to 9. In an alternative embodiment, the volumes and combinations of organic acid(s) may be predetermined and are dispensed and incorporated into the processing solution 90 by way of a predetermined time schedule.

Upon the overall processing time lapsing, the microprocessor 150 commands the piston cylinder 50 to position the rod 52 so that the container 60 is out of the processing solution 90, or the “default” position, where it remains until the operator releases the partial vacuum on the vacuum dip processor 40. The operator can then access the vacuum-processed fillets 26 by closing the ball valve 71, opening the ball valve 73 to break the vacuum seal, unlocking the locks 48, opening the lid 46, and removing the vacuum-processed fillets 26 from the container 60. The default position the container 60 is out of the process solution 90 to prevent chemical and osmotic damage and other undesired effects on the now vacuum-processed filets 26 as a result of unintended or prolonged exposure to the processing solution 90. The default position also minimizes operator contact with the processing solution 90. The operator then may further handle the vacuum-treated fillets 26 according to the ordinary practices of the processing industry, such as placing the product in a display packaging 28.

The vacuum dip processor 40 has a number of safety and override features to permit operator intervention when necessary. A manual stop button 208 on the control panel 200 permits the operator to manually terminate the overall processing of the biological or food product. Upon the operator pushing the manual stop button 208, the microprocessor 150 commands the piston cylinder 50 to position the rod 52 so that the container 60 reaches the default position. The vacuum dip processor 40 also has a “kill” switch (not shown) that disengages the piston cylinder 50 from operating when the lid 46 of the vacuum dip processor 40 is ajar.

The processing solution 90 is removed from the vacuum dip processor 40 by way of a drain 80 attached to the bottom dome 43 with a ball valve 82 attached. Best practice is to have a crow's foot connection 84 in conjunction with the ball valve 82 so as to permit attachment of a hose with similar crow's foot connection (not shown) to controllably drain the processing solution 90 from the vacuum dip processor 40. Spray nozzles (not shown) on the underside of the lid 46 may be actuated to assist cleaning the vacuum dip processor 40 of processing residue.

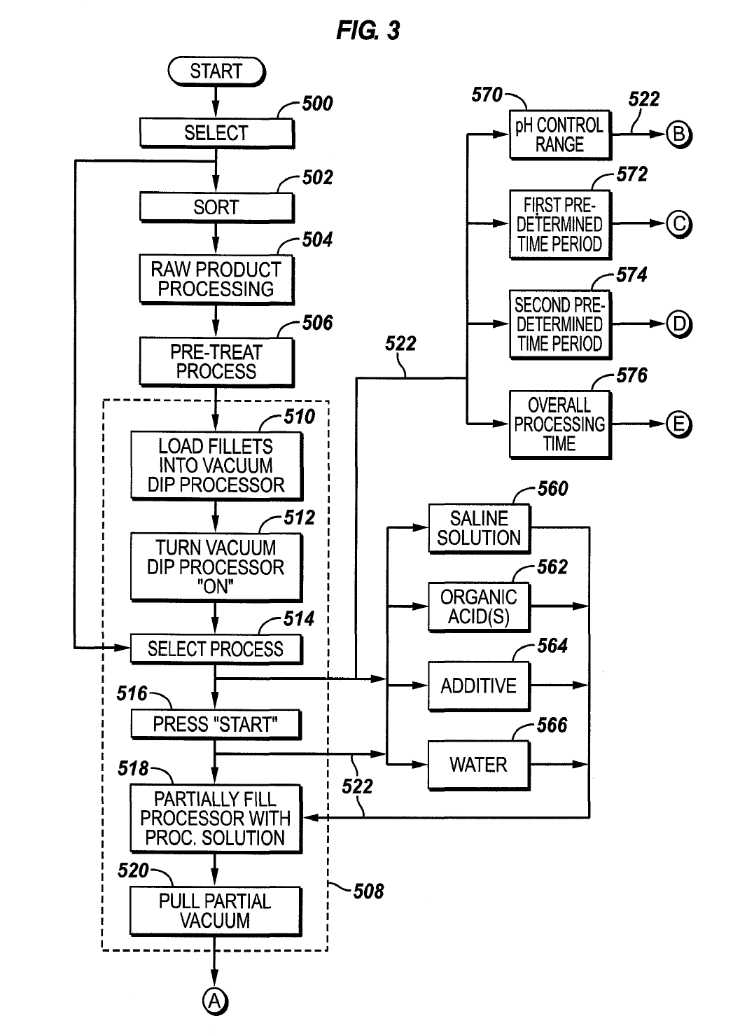

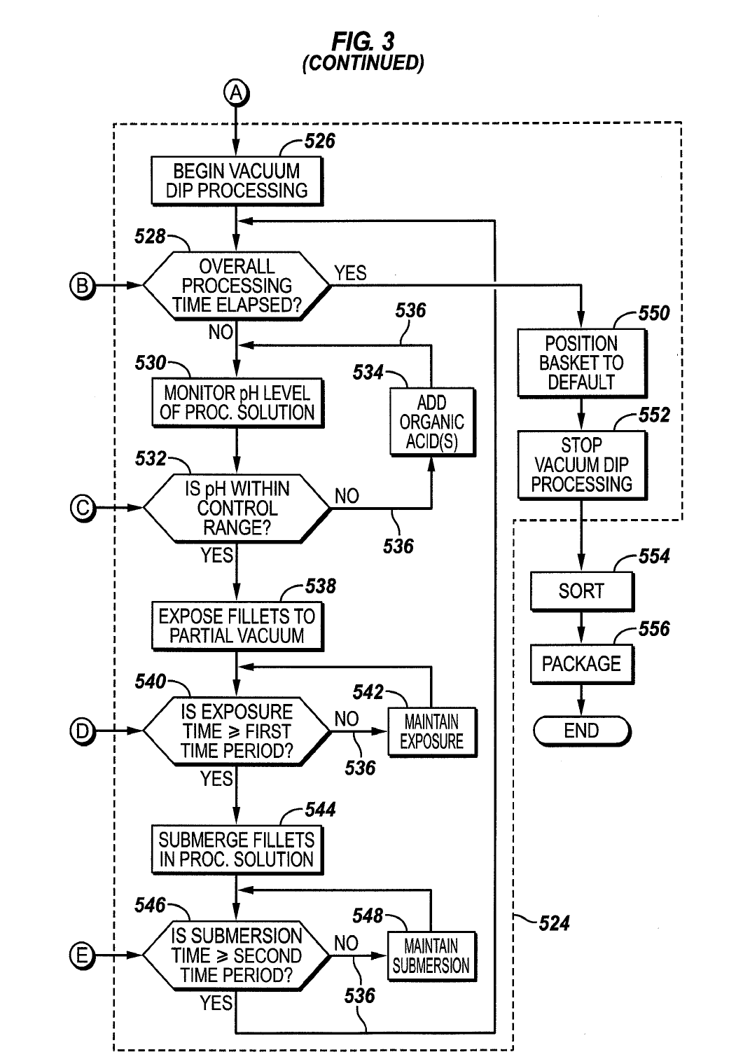

FIG. 3 is a flow diagram that illustrates the sequence of process steps performed by process 10, including the information flow between the operator input buttons on control panel 200, microprocessor 150, pH sensor 140, piston 50, water source 91, vacuum source 92, saline solution source 93, organic acid(s) source(s) 94, and additives source 95. It should be understood from the present invention that the process steps in FIG. 3 maybe performed in various sequences without departing from the scope of the present invention.

Processing begins with a selection of the food or biological product in a product selection block 500 to be later sorted in a product sorting block 502. The food or biological products are then processed in a raw product processing block 504, in the case of the prior red meat example the fillets 18, and then pretreated for processing in the pretreatment process block 506.

The following steps indicated by dashed block 508 indicate steps involving preparation of the vacuum dip processor 40 for processing. In a load fillets block 510 the pretreated fillets 22 are loaded into the vacuum dip processor 40 by inserting into the container 60 and closing and locking the vacuum dip processor 40. The operator then initiates the process by turning the vacuum dip processor 40 “on” in a on/off switch block 512, selects the proper process to perform in a process selection block 514, and presses the “start” button in a start process block 516. The information flow of an open loop system for determining the operational setting of the process selection switch 202 is received by the operator by the product selection block 500 via a feed-forward information line 522 from the production selection block 500. Processing solution 90 then fills the vacuum dip processor 40 at fill with solution block 518 and a partial vacuum is created in the vacant space within the vacuum dip processor at partial vacuum block 520. The vacuum dip processor 40 is now ready for processing pretreated fillets 22.

In one embodiment of the invention, data generated at process selection block 514 is fed forward to determine the composition of the processing solution 90. The selection of the process in block 514 in combination with the depressing of the “start” button in block 516 relays instructions via the feed-forward information lines 522 to the microprocessor 150 (not shown). The microprocessor 150, in response to the inputs from blocks 514 and 516, sends commands via the feed-forward lines 522 to distribute a fixed quantity of saline solution 560, organic acid(s) 562, additive 564, and water 566 to the vacuum dip processor 40 to create the process solution 90 specific to the selected process. Additionally, the microprocessor 150 also feeds forward variable values based upon the process selection block 514 for the pH control range 570, the first predetermined time period 572, the second predetermined time period 574, and the overall processing time 576.

The following steps indicated by dashed block 524 indicate steps involving processing of the pretreated fillets 22 into vacuum treated fillets 26. After beginning the vacuum dip processing at processing block 526, a comparison of the overall processing time 576 is made to the time elapsed in processing the pretreated fillets 22 in the overall processing time comparison block 528. If the decision block 528 determines that the overall processing time 576 has not elapsed, then vacuum dip processing continues. Upon continuation of processing, the pH level of the processing solution is obtained at pH monitoring block 530. The process pH value is compared to the pH control range 570 value at pH control range comparison block 532. If the process solution's 90 pH is not within the range set by the pH control range 570 value, a signal sent via feedback information line 536 to add additional organic acid(s) to the processing solution 90 at acid addition block 534. Upon addition of supplemental organic acid(s), the process is fed back via feedback information line 536 so that the processing solution 90 is evaluated again at the pH control range comparison block 532 for conformity to the pH control range 570 value. If the processing solution's 90 pH is within the range set by the pH control range 570 value, the process steps forward. Upon continuation of processing, the pretreated fillets 22 are exposed to the partial vacuum environment at exposure block 538. Upon exposing the pretreated fillets 22 to the partial vacuum, the first time period comparison block 540 compares the time of exposure of the pretreated fillets 22 to the partial vacuum to the first predetermined time period 572 value. If the exposure comparison block 540 determines that the pretreated fillets 22 have not been exposed long enough versus the value of the first predetermined time period 572 variable, the exposure is maintained at maintenance block 542 and the process feed back via feedback information line 536 for comparison again in the exposure comparison block 540. If the time of exposure is equal to or exceeds the first predetermined time period 572 value, the process steps forward. Upon continuation of processing, the pretreated fillets 22 are submerged into the processing solution 90 at submersion block 544. Upon submerging the pretreated fillets 22 to the processing solution 90, the second time period comparison block 546 compares the time of submersion of the pretreated fillets 22 to the second predetermined time period 574 value. If the submersion comparison block 546 determines that the pretreated fillets 22 have not been submerged long enough, the submersion is maintained at maintenance block 548 and the process feed back via feedback information line 536 for comparison again in the submersion comparison block 540. If the time of submersion is equal to or exceeds the second predetermined time period 572 value, the process steps forward and feeds back via feedback information line 536 to a point before the overall processing time comparison block 528. In this feedback loop, the vacuum dip processor 40 repeats the cycling of exposure and submersion that transforms pretreated fillets 22 into vacuum treated fillets 26 while controlling, depending on the product being processed, both the individual exposure times to the partial vacuum and process solution environments. This gives the improved and novel benefit of minimizes overall processing time while achieving maximum beneficial effects with minimal product damage. When overall processing time comparison block 528 determines that the overall processing time has elapsed based upon the overall processing time 576 variable, then the vacuum dip process proceeds through termination steps. The container 60 is positioned in the “default” position in “default” position block 550 and the vacuum dip processor 40 processing ends at end processing block 552.

After the vacuum dip processor 40 has halted processing, the overall process continues at block 554 where the vacuum dip processed fillets 26 are sorted at block 554 and then packaged at block 556 to produce packaged fillets 28.

Although the present invention is described with several embodiments, various changes and modifications may be suggested to one skilled in the art. In particular, the present invention is described with reference to red meat, but may apply to other animal products with little alteration and similar results. Furthermore, the present invention contemplates several process steps that may be performed in the sequence described or in an alternative sequence without departing from the scope and the spirit of the present invention. The present invention is intended to encompass such changes and modifications as they fall within the scope and the spirit of the appended claims.

What is claimed is:

1. A method for treatment of biological or food products, comprising:
exposing a biological or food product for a first predetermined length of time to a partial vacuum;
submerging the biological or food product for a second predetermined length of time in a process solution; and
alternating repetitively the exposure and submergence of the biological or food product by an axial motion for the respective first and second predetermined lengths of time until an overall processing time has elapsed.

2-3. (canceled)

4. The method of claim 1, wherein the process solution comprises:
a saline solution,
water, and
at least one organic acid.

5-10. (canceled)

11. The method of claim 1, wherein the alternating repetitively the exposure and submergence of the biological or food product by an axial motion is controlled by a microprocessor.

12. A method for the treatment of a food or biological products, comprising:
loading the food or biological product into a vacuum dip processor;
filling the vacuum dip processor partially with a process solution;
creating a partial vacuum in the vacuum dip processor by removing part of the remaining air in the vacuum dip processor;
alternating repetitively the food or biological product between submersion in the process solution and the exposure to the partial vacuum by an axial motion.

13-22. (canceled)

23. The method of claim 12, wherein the alternating repetitively the food or biological product between submersion in the process solution and the exposure to the partial vacuum occurs for a predetermined length of time.

24. The method of claim 23, wherein the predetermined length of time is based upon the biological or food product being processed.

25. The method of claim 12, wherein process of the filling the vacuum dip processor with a processing solution is controlled by a microprocessor.

26. The method of claim 12, wherein process of the creation of a partial vacuum in the vacuum dip processor is controlled by a microprocessor.

27. The method of claim 12, wherein the process of alternating repeatedly the exposure and submersion of the biological or food product by an axial motion is controlled by a microprocessor.

28. An apparatus for processing a variety of food or biological products, comprising:
a vacuum dip processor having a top cover and a bottom cover, wherein an air-tight seal is formed with the vacuum dip processor when the top cover and the bottom cover are in a closed position;
a rod positioned vertically within the interior of the vacuum dip processor and is axially movable;
a container for containing the food or biological products and removably attached to the rod, wherein the container is axially movable between a first position located within the partial vacuum space inside the vacuum dip processor and a second position located within the vacuum dip processor;
a processing solution filled to a liquid level within the vacuum dip processor, wherein the container is submerged within the processing solution when the container is located at the second position;
a vacuum source in communication with the vacuum dip processor, wherein the vacuum source is capable of creating a partial vacuum in the space above the processing solution inside the vacuum dip processor; and
a piston cylinder attached to the rod, wherein the piston cylinder allows the container to axially move between the first position and the second position by axially moving the rod.

29-41. (canceled)

42. The apparatus of claim 28, wherein the process solution comprises:
water;
at least one organic acid; and
a saline solution.

43. The apparatus of claim 42, wherein the at least one organic acid comprises one or more of the following:
citric acid; and
ascorbic acid.

44. The apparatus of claim 42, wherein the processing solution also comprises one or more of the following:
potassium chloride;
sodium phosphate; and
potassium phosphate.

45. The apparatus of claim 28, wherein the partial vacuum created in the space above the processing solution is at least 25 inches of mercury (in. Hg).

46-55. (canceled)

56. The apparatus of claim 28, further comprising a pH sensor communicably linked to the vacuum dip processor.

57. The apparatus of claim 56, further comprising a microprocessor communicably linked to the pH sensor.

58. The apparatus of claim 57, wherein the microprocessor controls the pH level of the process solution based upon a pH value detected by the pH sensor.

59. The apparatus of claim 58, wherein the pH level is maintained within a pH range of 1 and 9.

60-68. (canceled)

69. The apparatus of claim 28, further comprising an additives source in communication with the vacuum dip processor containing one more of the following additives:
potassium chloride;
sodium phosphate; and
potassium phosphate.

70. The apparatus of claim 69, further comprising a microprocessor in communication with the additives source.

71. The apparatus of claim 70, wherein the microprocessor controls the amount of the additive distributed to the vacuum dip processor.
